(19) United States
(12) Patent Application Publication
(10) Pub. No.: US 2005/0176489 A1
(43) Pub. Date: Aug. 11, 2005

(54) Data processing system for the organisation of lotteries

(76) Inventors: Rudiger Kroll, Hamburg (DE); Oswald Romer, Hamburg (DE); Sven Tissot, Hamburg (DE)

Correspondence Address: Guy D Yale;Alix Yale & Ristas, 750 Main Street, Suite 1400, Hartford, CT, 06103, US

(21) Appl. No.: 10/513,375

(22) PCT Filed: May 3, 2002
(86) PCT No.: PCT/EP02/04895

(51) Int. Cl. A63F 13/00

(52) U.S. Cl. 463/17; 463/42

(57) ABSTRACT

The data processing system for the organization of lotteries by means of the internet is characterized in that winning numbers generated by a random number generator are provided with a signature, which can be checked within the system by the playing user such as to be able to securely verify such manipulations.

The invention relates to a data processing system for the organization of lotteries with a first subsystem (frontend), which can be accessed externally via the Internet, and with a second subsystem (backend), which is connected to the first subsystem by means of a device preventing unauthorized access and is otherwise locked.

Data processing systems of this kind are known in connection with the Internet. Although an Internet subscriber has access to a first subsystem where he can input data, can have data displayed, can receive general information and can be forwarded to other links if appropriate, he has no direct access to the data in a second subsystem connected to the first by a firewall. Rather, the data which the Internet subscriber needs to access are transferred from the second subsystem to the first subsystem only selectively.

Internet applications are diverse and are enjoying steadily rising popularity. In this context, however, certain areas are particularly sensitive. For lotteries, there are strict regulations so that the wins cannot be manipulated.

A system has been proposed (European patent application 00 124 085.2) which permits the organization of lotteries via the Internet. This system is distinguished in that the second subsystem (backend) has a random generator, memory devices for data from game participants in a lottery, including the lottery numbers which have been allocated to the players, a win schedule and a computer for attributing wins, on the basis of the numbers generated in the random number generator, to game participants with lottery numbers which correspond to the numbers, and in that the first subsystem contains a computer for interchanging data with the game participants, and the second subsystem contains an e-mail facility for notifying the winners.

Such a system affords a high level of security, with the particularly security-related parts, particularly the random number generator, also being protected by mechanical protective measures such as a closed housing with seals, etc. Nevertheless, an even higher level of security is desirable. In particular, the aim here is also to provide the game participant with the opportunity to check the authenticity of the random numbers generated, i.e. of the winning numbers drawn.

The object of the invention is therefore to provide a data processing system in which the protection against manipulation is increased further.

In a data processing system cited at the outset, the inventive solution involves the random number generator being connected to devices for providing the generated numbers with the signature of a private key which are accommodated securely together with the random number generator, the signature being able to be checked using a public key.

Each random number generated is thus provided directly with a signature which is generated using a private key. The signature uses an algorithm which is dependent on the private key to calculate signature values which are appended to the random number's data record. If the number generated is subsequently changed, then the signature for this number is no longer correct. An outsider who is not in possession of the private key is therefore unable to generate a changed random number with an appropriate signature. In this case, the signature may be checked using a public key. Within the system in the field of the lottery, it is therefore possible to check at any point whether the signature matches the randomly generated number linked thereto or whether any manipulation has taken place. It is also possible to make the public key available to the game participants, so that they may likewise check the authenticity of the numbers generated. If the random number generator and the device for generating the signature are reliably locked to the outside, for example in a sealed housing, then it is no longer possible to manipulate the random number without this being noticed, since the signature does not match the manipulated random number.

Expediently, the second subsystem (backend) actually contains devices for checking the signature of the generated random numbers. If this is the case there is no need for this part of the second subsystem to be sealed together with the random number generator.

The absolutely secure generation of random numbers which are no longer able to be manipulated means that there is no longer any need per se for logging using a printer. Expediently, however, such a printer may still be provided if one wishes to provide proof which can also be comprehended by a person who does not understand the technical structure of the system.

The random number generator, which needs to be encapsulated particularly securely, does not need to be accommodated in the same room as the computer which allocates the wins. The random number generator with the device for generating the signature may be arranged, by way of example, in a room belonging to the lottery operator, while the computer is situated in a computer center which is connected to the Internet. The data transfer between the random number generator and the computer center then expediently takes place via an encrypted data connection, e.g. a leased line or ISDN.

Expediently, the data processing system has a timer which initiates the generation of final digits and the attribution of wins (draw) at regular intervals of time, particularly once daily. This timer may likewise be arranged in the computer center and may then be connected to the random number generator via an encrypted data connection so that only this timer is able to initiate the generation of random numbers.

Advantageously, devices for game participants to download certificates which can be used to check the signature of the generated numbers are provided. This certificate, which the game participant may download via the Internet, firstly contains the public key which can be used to check the signature of the generated numbers. Secondly, the certificate contains the lottery operator's identification, inter alia.

The system is advantageously designed to use XML signatures; the corresponding type of logging and of data interchange between the subsystems and to the game participant is particularly advantageous for the system.

Advantageously, the system has a smart card reader for the private key. The corresponding smart card can then be applied for at a trust center (e.g. Deutsche Post, Telekom or others). This smart card is then sealed together with the random number generator.

The winning numbers are generated by the random number generator, where it is naturally necessary to ensure that genuine random numbers are generated and that certain numbers are not generated significantly more often than other numbers. A random number generator which determines its numbers using a physical noise source, e.g. semiconductor noise, has been found to be particularly expedient in this context. This random number generator can generate any length (max. 20 places) of final digits (e.g. lottery numbers containing two final digits, lottery numbers containing three final digits, etc.) which are intended to result in wins. This random number generator is naturally not accessible from the outside, particularly from the first subsystem (frontend system). The second subsystem (backend system) also contains memory devices (database) for data from game participants in a lottery, including lottery numbers which have been allocated to the players. In this case, the data from game participants include names, address, bank details and possibly telephone numbers, e-mail addresses and the like. In addition, the lottery numbers which the game participant uses to play the lottery are stored. Any mention of game participants here naturally refers not only to game participants of male sex but also to those of female sex. In addition, the memory devices contain a win schedule which stipulates the level of the wins for a particular instance of random numbers being generated (final digits being drawn) when the lottery line contains the correct final number, the correct last two final numbers, etc. The corresponding association between the wins and the lottery lines and hence the game participants is then made using a computer which is arranged in the second subsystem.

Operation is automatic. In particular, as already mentioned, provision may be made for the data processing system to have a timer which initiates the generation of random numbers and the attribution of wins (draw) at regular intervals of time, particularly once daily at a prescribed time of day. It goes without saying that it is also possible for such a draw to be made more than once a day. In this case, the participant can use the Internet to find out about the winning numbers and may even track the generation of these winning numbers if appropriate. A game participant may also receive other general information. In particular, provision is also made for the or a computer in the first subsystem to generate a mask for the game participant's screen into which said game participant can enter data. Here, the game participant can log on and can enter his name, his address, bank details, and method of payment. As soon as the payment has then been received by transfer, or the payment has been authorized by the credit card institute or the like which the game participant wishes to use, the game participant may pick one or more lottery numbers in one advantageous embodiment. The number of lottery lines which the game participant may select can be limited in this case.

With the exception of the fact that the game participant needs to input his personal data and the desired lottery numbers, operation is automatic. The payment of wins is likewise automatic, specifically to the bank account specified by the game participant. In addition, provision may be made for game participants to be granted cost-free participation in one or more draws (bonus lottery lines) as a win. This may be the case, for example, when the player has the correct final number in his lottery number in the draw in question.

In addition, there may be provision that, with the exception of bonus lottery lines, it is possible to participate in a prescribed number of draws only. In one advantageous embodiment, it would be possible for there to be, by way of example, four consecutive classes (weekly draws) with seven respective draws (one on each day) so that the entire cycle is repeated after every 28 days. The fact that a minimum number of draws needs to be chosen increases the attractiveness of the lottery, since there is a greater number of chances to win.

For the purpose of data integrity, provision is advantageously made for only data from the game participant who is currently accessing the system to be transferred from the second to the first subsystem and to be transferred back to the second subsystem or erased after a prescribed time there. This provides the greatest possible data integrity and gives the greatest possible protection against data manipulation. The fact that access to the first subsystem is also secure as a result of a firewall and that game participants have access only with a password goes without saying in this context and is in line with the practice which is current for many other Internet pages.

Provision is advantageously made for one or more of the computers to perform an authorization check either in the second subsystem, but advantageously actually in the first subsystem. Thus, by way of example, the zip code can be used to check whether the game participant actually lives in an area in which the lottery is housed.

Each computer and memory is expediently supplemented by a second in order to be able to continue operation if the first fails.

As has already been mentioned, operation is fully automatic. It is naturally only necessary for the game participant to input his data manually. The authorization check for credit cards, payments received and the like is performed automatically, however, as is the payment of wins.

As already mentioned, firewalls ensure that no unauthorized access to the system or to components of the system is possible. However, it has been found to be particularly advantageous in combating the risk of manipulation if the fundamental parts of the system are mechanically sealed. Thus, by way of example, the random number generator could be accommodated with the smart card reader in a sealed transparent housing so that it cannot be manipulated. It goes without saying that this housing needs to be provided with ventilation holes if necessary.

Expediently, provision is also made for all fundamental operations, particularly the generation of the final digits, to be logged. This may be done in an electronic form or else by printing on paper, although the latter is no longer necessary on account of the signatures.

The invention is described by way of example below using an advantageous embodiment with reference to the appended drawings, in which:

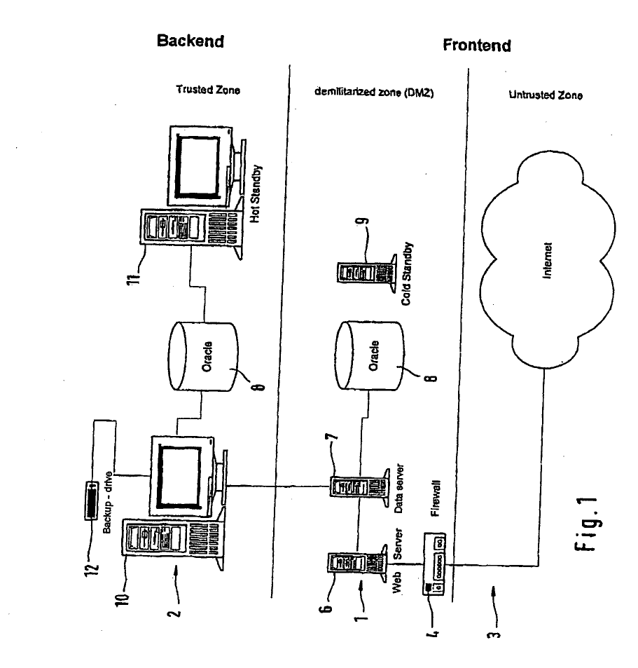

FIG. 1 shows a schematic illustration of the design of part of the inventive data processing system;

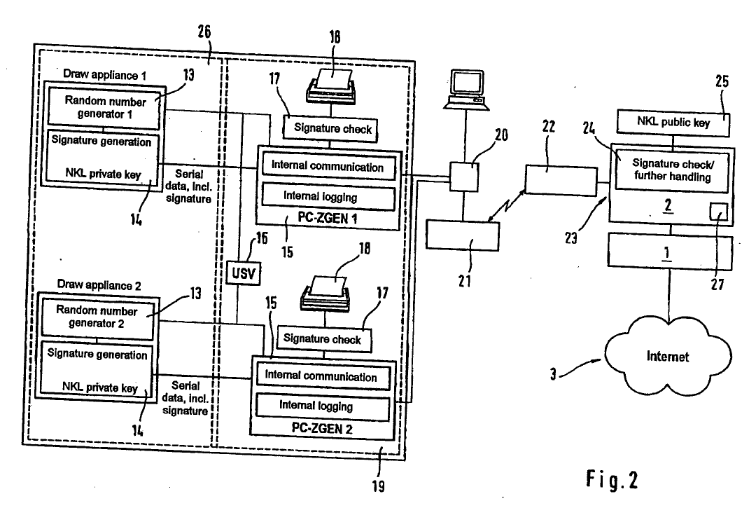

FIG. 2 shows a schematic illustration of the entire system; and

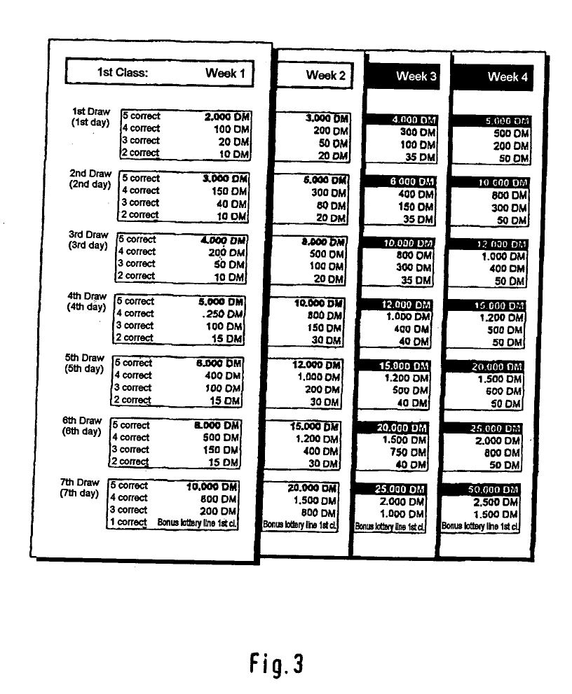

FIG. 3 shows an example of a win schedule.

The data processing system shown in FIG. 1 has three areas, namely the freely accessible Internet area 3, the first subsystem 1 and the second subsystem 2. In this case, the first subsystem 1 is isolated from the freely accessible Internet area 3 by a firewall 4. Access to data which go beyond general information is possible only using a password. The first subsystem 1 is isolated from the second subsystem 2 by a “logic” firewall. The first subsystem has a web server 6 and a data server 7 which is linked to a data structure 8. At 9, a backup computer is shown which can be used if the computer 6 or 7 fails. The second subsystem 2 contains a primary computer 10, with another backup computer being connected at 11, said backup computer being able to perform the functions of the computer 10 if the latter fails. The link is made via a database system 8. At 12, a backup drive is also shown, which stores the data in addition to the storage in the computers 10 and 11. In the embodiment shown here, the random number generator is accessed by the computers 10 and 11. The second subsystem 2 is connected to banks, credit card institutes etc. by means of access via the Internet.

FIG. 2 shows the entire system, including the random number generators 13, which are enclosed by a locked container 26 indicated by dashed lines. The random number generators 13 are provided with smart card readers 14 and corresponding signature generation devices. Normally, only one unit 13, 14, i.e. the draw appliance 1, is working. Only if this fails does the draw appliance 2 undertake its function. The data are then forwarded to internal communication and logging units 15. Power is supplied by an uninterruptible power supply 16. At 17, a signature check can be performed, in which case a log can be produced on a printer 18. The corresponding units 15 to 18 are likewise provided in duplicate and may be arranged in a separately protected room 19. The random numbers with a signature are then forwarded using a switching unit 20 and terminals 21, 22 on a data connection, these terminals 21 and 22 encrypting and decrypting the data, so that only encrypted data are sent to a computer center indicated at 23. This computer center has a unit 24 for signature checking. Only if the random numbers generated are confirmed as unmanipulated by this unit 24 does the further processing in units 2 (backend) and 1 (frontend) and via the Internet 3 take place, as shown in FIG. 1. At 25, there is also an indication that the unit 23 also delivers the public key, which can be requested via the Internet, for example, so that game participants can check the authenticity of the random numbers generated, i.e. of the winning numbers.

In the backend 2 in FIG. 2, a timer 27 is also indicated which uses encrypted data connections (not shown) to prompt the generation of random numbers at regular intervals, particularly once daily.

A win schedule is shown in FIG. 3. The lottery extends over four respective weeks of seven days. Every day, a draw is held. A player must respectively participate on 28 consecutive days, for example, but with the first day being able to be any day in the 28-day cycle. Only in the case of a bonus lottery line is it possible to participate in just one class, namely in the first class of the next lottery.

The lottery is handled entirely without paper via the Internet, with, at most, provision possibly having been made for the numbers from the random number generator or their protocols to be sent to the financial authority as a paper copy.

The game participant calls up the Internet page and is first of all able to view general information, particularly an online presentation of the lottery, there. He can then log in or re-register. In this case, passwords are used. The ordering of lottery lines, the input of the data from the game participant, including the input of payment information, and the selection of lottery lines are performed using an input mask. However, the lottery line is not activated until payment has been made by bank transfer or else payment has been authorized by the credit card institute. These Internet pages are then also used to show the generation of the final digits. In this case, the game participant may also find out whether he has won. While he or she has got the Internet page called up, personal data are also transferred from the second secure subsystem to the first subsystem. If the game participant breaks the connection or else after a prescribed time in which the game participant has not been active again, these data are transferred back to the secure second subsystem or else are erased. Management of the customer bills, processing of the draws, notification of wins, the management of master data, etc. take place in the secure second subsystem. The payment transactions, the online validation of payment data, the data traffic with the bank (transfers, credits and debits) are likewise advantageously performed via the Internet.

At precisely defined intervals of time, once daily always at the same time in the example in FIG. 3, final digits are generated. As a result, the lottery lines with one correct final number, with two correct final numbers etc. are ascertained and then attributed a win on the basis of the win schedule. This win is then automatically transferred to the bank account specified by the game participant.

For the purpose of security, provision is expediently made for electronic lottery lines to be produced which are provided with information about lottery number, customer number, participation period, game participant's current account—which are all digitally encrypted—so that the electronic lottery lines are protected against alteration.

Expediently, the database 8 used in FIG. 1 is an Oracle database. Other databases might likewise be used in theory, although this should not primarily be geared thereto.

For the check regarding whether the game participant is actually authorized to participate in the game, he needs to indicate whether he is over 18 years old, and also local authorization is verified (if there are restrictions in this regard) by checking the zip code.

1. A data processing system for the organization of lotteries with a first subsystem, which can be accessed externally via the Internet, and with a second subsystem, which is connected to the first subsystem by means of a logic device preventing unauthorized access and is otherwise locked, where
the second subsystem has:
a random number generator,
memory devices for data from game participants in a lottery, including lottery numbers which have been allocated to the players, and a win schedule,
a computer for attributing wins, on the basis of numbers generated in the random number generator, to game participants with lottery numbers which correspond to the numbers, and
an e-mail facility for notifying the winners,
and where the first subsystem contains a computer system for interchanging data with the game participants and for notifying the winners,
characterized in that, the random number generator is connected to devices for providing the generated numbers with the signature of a private key which is accommodated securely together with the random number generator, the signature being able to be checked using a public key.

2. The data processing system as claimed in claim 1, characterized in that the second subsystem contains devices for checking the signature of the generated numbers.

3. The data processing system as claimed in claim 1, characterized in that the second subsystem contains a printer for logging.

4. The data processing system as claimed in claim 1, characterized in that the random number generator is connected to the computer system which allocates the wins via an encrypted data connection.

5. The data processing system as claimed in claim 1, characterized in that it has a timer which initiates the generation of final digits and the attribution of wins at regular intervals of time and is connected to the random number generator via an encrypted data connection.

6. The data processing system as claimed in claim 1, characterized in that it has devices for game participants to download certificates which can be used to check the signature of the generated numbers.

7. The data processing system as claimed in claim 1, characterized in that it is designed to use XML signatures.

8. The data processing system as claimed in claim 1, characterized in that it has a smart card reader for the private key.

9. The data processing system as claimed in claim 1, characterized in that the random number generator has a physical noise source.

10. The data processing system as claimed in claim 1, characterized in that the computer in the first subsystem generates a mask for the game participant's screen into which said game participant can enter data.

11. The data processing system as claimed in claim 10, characterized in that the mask contains options for the game participant to input one or more lottery numbers which the game participant can select.

12. The data processing system as claimed in claim 1, characterized in that participation in the lottery is not activated until payment of the stake has been made or confirmed.

13. The data processing system as claimed in claim 1, characterized in that wins are paid automatically into the bank account specified by the game participant.

14. The data processing system as claimed in claim 1, characterized in that game participants may be granted cost-free participation in one or more draws as a win.

15. The data processing system as claimed in claim 1, characterized in that with the exception of bonus lottery lines it is possible to participate in a prescribed number of draws only.

16. The data processing system as claimed in claim 1, characterized in that only data from the game participant who is currently accessing the system are transferred from the second to the first subsystem and are transferred back to the second subsystem or erased after a prescribed time there.

17. The data processing system as claimed in claim 1, characterized in that at least one computer performs an authorization check.

18. The data processing system as claimed in claim 1, characterized in that each computer and memory is supplemented by a second which continues operation if the first fails.

19. The data processing system as claimed in claim 1, characterized in that operation is fully automatic.

20. The data processing system as claimed in claim 1, characterized in that the fundamental parts of the random generator and of the devices for providing the signature are mechanically sealed.

21. The data processing system as claimed in claim 1, characterized in that all fundamental operations are logged.

22. The data processing system as claimed in claim 1, characterized in that it is connected to the Internet.

23. The data processing system as claimed in claim 1, characterized in that the fundamental elements of the system are provided in duplicate.
